(19) United States
(12) Patent Application Publication
(10) Pub. No.: US 2026/0264404 A1
(43) Pub. Date: Sep. 10, 2026

(54) JET HOLE PLATE, HEAD CHIP, LIQUID JET HEAD, LIQUID JET RECORDING APPARATUS, AND METHOD OF MANUFACTURING JET HOLE PLATE

(71) Applicant: SII Printek Inc., Chiba-shi (JP)

(72) Inventors: Toshimitsu MOROOKA, Chiba-shi (JP); Kenji SUZUKI, Chiba-shi (JP); Yuichi TAKAHAMA, Chiba-shi (JP); Tooru MINE, Chiba-shi (JP); Naoto WADA, Chiba-shi (JP)

(21) Appl. No.: 19/558,937

(22) Filed: Mar. 6, 2026

(30) Foreign Application Priority Data
Mar. 10, 2025 (JP) 2025-037493

(51) Int. Cl. B41J 2/14; B41J 2/16

(52) U.S. Cl. CPC B41J 2/1433; B41J 2/162; B41J 2/1632; B41J 2002/14475

(57) ABSTRACT

A jet hole plate, a head chip, a liquid jet head, a liquid jet recording apparatus, and a method of manufacturing the jet hole plate which are high in quality are provided while achieving the reduction in cost. The jet hole plate according to an aspect of the present disclosure is provided with a plate main body provided with a jet hole configured to jet a liquid. The jet hole is provided with a taper portion which has a circular-arc inner peripheral surface formed in a circular arc shape having a uniform curvature radius in a cross-sectional surface along a jet direction, opens on the first surface, and in which an inside diameter at a position gradually decreases as the position moves downstream, and a straight portion which is connected to a downstream end portion of the taper portion, opens on the second surface, and is formed to have a uniform inside diameter throughout an entire length in the jet direction. When a dimension in the jet direction of the plate main body is denoted by H, a dimension in the jet direction of the straight portion is denoted by h, and a curvature radius of the circular-arc inner peripheral surface is denoted by r, 1<r/(H-h) is satisfied.

### RELATED APPLICATIONS

This application claims priority to Japanese Patent application No. JP2025-037493, filed on Mar. 10, 2025, the entire content of which is incorporated herein by reference.

### BACKGROUND OF THE INVENTION

### 1. Field of the Invention

The present disclosure relates to a jet hole plate, a head chip, a liquid jet head, a liquid jet recording apparatus, and a method of manufacturing a jet hole plate.

### 2. Description of the Related Art

There has been an inkjet printer equipped with an inkjet head as an apparatus that ejects ink shaped like a droplet to a recording target medium such as recording paper to thereby record an image and characters on the recording target medium. The inkjet head is provided with a head chip in which channels are formed, and a nozzle plate in which nozzle holes communicating with the channels are formed.

According to this configuration, due to an increase in pressure in the channel, the ink in the channel is ejected through the nozzle hole as a droplet. Specifically, the ink is ejected from the nozzle hole in a columnar shape (like a ligament), and is then separated into a plurality of droplets in some cases. In this case, out of the plurality of droplets, the droplet flying foremost is called a main droplet, and the droplets located behind the main droplet are called satellites.

Incidentally, recently, an improvement of the print quality is achieved by reducing the size of the droplet ejected at a time from the nozzle hole (so-called small droplet printing). In order to achieve the improvement of the print quality by the small droplet printing, it is necessary to suppress an occurrence of the satellites described above.

Further, for example, in so-called wide gap printing which is performed with a print surface of a recording target medium and the inkjet head at a distance from each other, there is an advantage that, for example, printing can be performed even when the print surface is an uneven surface. However, in the wide gap printing, since the time during which the droplet flies is long, there is a problem that the satellites described above easily occur.

In, for example, International Patent Publication No. WO 2017/126611 and JP2006-224619A, there is disclosed a variety of shapes regarding the nozzle hole.

Specifically, the nozzle hole disclosed in International Patent Publication No. WO 2017/126611 is formed so that the cross-sectional shape is a curved-line shape, and is formed to have a taper shape in which the inside diameter at a position gradually decreases as the position moves from an ink inflow side toward an ink ejection side.

The nozzle hole disclosed in JP2006-224619A is provided with a taper portion shaped like a circular truncated cone, a straight portion located downstream of the taper portion, and a curved surface portion which joins the taper portion and the straight portion.

However, in the configuration related to International Patent Publication No. WO 2017/126611, since the entire nozzle hole in the thickness direction of the nozzle plate is formed in the taper shape, there is a possibility that the droplet is ejected while keeping the velocity component in the radial direction (a direction perpendicular to the thickness direction) of the nozzle hole. In this case, there is a problem that a deflection and a variation in the ejection direction of the droplet easily occur, and the satellites easily occur. Further, since the cross-sectional area of the nozzle hole in a direction perpendicular to the thickness direction varies in the entire length in the thickness direction, it is difficult to process an outlet bore of the nozzle hole to a desired size. As a result, there is a possibility that an increase in manufacturing cost is incurred.

In the configuration related to JP2006-224619A, although the curved surface portion is disposed in a boundary portion between the taper portion and the straight portion, it is difficult to ensure the dimension of the curved surface portion while maintaining the thickness of the nozzle plate. Therefore, it is difficult to suppress a turbulent flow generated in the boundary portion. As a result, in the related-art technique, there is still a room for improvement in suppressing the deflection and the variation in ejection direction of the droplet and the occurrence of the satellites.

The present disclosure provides a jet hole plate, a head chip, a liquid jet head, a liquid jet recording apparatus, and a method of manufacturing the jet hole plate which are high in quality while achieving the reduction in cost.

### SUMMARY OF THE INVENTION

In order to solve the problems described above, the present disclosure adopts the following aspects.
(1) A jet hole plate according to an aspect of the present disclosure includes a plate main body provided with a jet hole configured to jet a liquid, wherein when defining a surface facing upstream in a jet direction of the liquid as a first surface, and a surface facing downstream as a second surface, the jet hole includes a taper portion which has a circular-arc inner peripheral surface formed in a circular arc shape having a uniform curvature radius in a cross-sectional surface along the jet direction, opens on the first surface, and in which an inside diameter at a position gradually decreases as the position moves toward the downstream, and a straight portion which is connected to a downstream end portion of the taper portion, opens on the second surface, and is formed to have a uniform inside diameter throughout an entire length in the jet direction, when a dimension in the jet direction of the plate main body is denoted by H, a dimension in the jet direction of the straight portion is denoted by h, and a curvature radius of the circular-arc inner peripheral surface is denoted by r, 1<r/(H-h) is satisfied.

According to the present aspect, the liquid which has flowed into the jet hole is gradually increased in flow rate in the process of passing through the taper portion, and is then straightened in the process of passing through the straight portion. Thus, it is possible to eject the liquid from the jet hole in the state in which a velocity component in the radial direction of the jet hole is reduced. On this occasion, since the inner peripheral surface of the taper portion is formed as the circular-arc inner peripheral surface, the velocity component is easily reduced in the radial direction of the jet hole as the ink moves downstream compared to when, for example, the inner peripheral surface of the taper portion is formed in a linear shape. Further, it is possible to suppress an occurrence of a turbulent flow in the connection portion of the taper portion and the straight portion. Thus, it is possible to reduce a deflection and variations in ejection direction and jet velocity of the droplet. Further, it becomes possible to suppress the occurrence of the satellites to thereby perform the small droplet printing and the wide gap printing with high quality.

Moreover, since the straight portion forms a downstream opening portion of the jet hole, it is possible to reduce a dimensional variation with respect to the inside diameter of the downstream opening portion compared to a configuration in which, for example, the whole of the jet hole is formed as the taper portion. Thus, it is possible to provide the jet hole plate low in cost and high in quality.

In particular, since the dimensions are set within the range of 1<r/(H-h), it is possible to suppress a growth in size of the inside diameter with respect to the upstream opening portion of the jet hole. Thus, when providing a plurality of jet holes to the jet hole plate, it becomes possible to miniaturize the jet holes and to narrow a pitch of the jet holes, and it becomes possible to reduce the size of the head chip in which the jet hole plate is installed, and to improve the print quality.
(2) In the jet hole plate according to the aspect (1) described above, it is preferable to satisfy r/(H-h)≤5.

According to the present aspect, by setting the dimensions to satisfy r/(H-h)≤5, a change in inside diameter of the jet hole in the taper portion can be made gentle. Thus, a change in velocity in the process of passing through the taper portion can be made gentle, and thus, the occurrence of the turbulent flow in the jet hole can be suppressed. As a result, it is possible to achieve a further improvement in print quality.
(3) In the jet hole plate according to the aspect (1) or (2) described above, the straight portion has a straight inner peripheral surface which extends linearly in the jet direction in a cross-sectional surface along the jet direction, and is connected to the circular-arc inner peripheral surface in an upstream end portion in the jet direction, and when an angle between a straight line connecting an intersection of the circular-arc inner peripheral surface and the first surface and an intersection of the circular-arc inner peripheral surface and the straight inner peripheral surface and the jet direction is denoted by γ, and an angle between a tangent direction of the circular-arc inner peripheral surface at a connection portion of the circular-arc inner peripheral surface and the straight inner peripheral surface and the jet direction in the cross-sectional surface along the jet direction is denoted by θ, it is preferable to satisfy 0°≤θ≤γ/2.

According to the present aspect, since it is possible to smoothly connect the taper portion (the circular-arc inner peripheral surface) and the straight portion (the straight inner peripheral surface) to each other, it is possible to suppress the occurrence of the turbulent flow in the connection portion of the taper portion and the straight portion.
(4) In the jet hole plate according to the aspect (3) described above, it is preferable to satisfy θ≤10°.

According to the present aspect, since it is possible to smoothly connect the taper portion (the circular-arc inner peripheral surface) and the straight portion (the straight inner peripheral surface) to each other, it is possible to suppress the occurrence of the turbulent flow in the connection portion of the taper portion and the straight portion. Further, it is possible to suppress a growth in size of the inside diameter with respect to the upstream opening portion of the jet hole while maintaining the state in which the circular-arc inner peripheral surface is sufficiently curved.
(5) In the jet hole plate according to the aspect (3) or (4) described above, it is preferable to satisfy 0.1°≤θ.

According to the present aspect, when, for example, forming the jet hole with the press work, it is possible to improve mold releasability of the punch taking the dimensional variation into consideration.
(6) In the jet hole plate according to any one of the aspects (1) through (5) described above, when an inside diameter of the straight portion is denoted by d, it is preferable to satisfy d/10≤h≤H/2.

According to the present aspect, since the dimension h of the straight portion is set to be no larger than a half the dimension H of the plate main body, it is easy to ensure the dimension of the taper portion. Thus, it is easy to reduce the velocity component in the radial direction of the jet hole as the liquid moves downstream. Further, it is possible to suppress an occurrence of a turbulent flow in the connection portion of the taper portion and the straight portion.

On that basis, since the dimension h of the straight portion is set to be no smaller than 1/10 of the inside diameter d of the straight portion, it is possible to exert the straightening effect of the liquid in the straight portion.
(7) In the jet hole plate according to the aspect (6) described above, it is preferable to satisfy d/4≤h.

According to the present aspect, it is possible to ensure the dimension of the straight portion to make it possible to increase the straightening effect.
(8) A head chip according to an aspect of the present disclosure includes the jet hole plate according to any one of the aspects (1) through (7) described above.

According to the present aspect, it is possible to provide a head chip high in print quality.
(9) A liquid jet head according to an aspect of the present disclosure includes the head chip according to the aspect (8) described above.

According to the present aspect, it is possible to provide a liquid jet head high in print quality.
(10) A liquid jet recording apparatus according to an aspect of the present disclosure includes the liquid jet head according to the aspect (9) described above.

According to the present aspect, it is possible to provide a liquid jet recording apparatus high in print quality.
(11) A method of manufacturing a jet hole plate according to an aspect of the present disclosure is a method of manufacturing a jet hole plate which is provided with a plate main body provided with a jet hole configured to jet a liquid, wherein when defining a surface facing upstream in a jet direction of the liquid as a first surface, and a surface facing downstream as a second surface, the jet hole includes a taper portion which opens on the first surface and in which an inside diameter at a position gradually decreases as the position moves toward the downstream, and a straight portion which is connected to a downstream end portion of the taper portion, opens on the second surface, and is formed to have a uniform inside diameter throughout an entire length in the jet direction, the method including a press process of performing a press work from the first surface of the plate main body using a punch including a taper shaping portion configured to shape the taper portion and a straight shaping portion which is continued to a tip of the taper shaping portion and is configured to shape the straight portion.

According to the present aspect, it is possible to accurately and promptly shape the jet hole having the taper portion and the straight portion in the desired shape compared to when manufacturing the jet hole plate having the jet hole by, for example, plating.

According to an aspect of the present disclosure, it is possible to provide a jet hole plate, a head chip, a liquid jet head, a liquid jet recording apparatus, and a method of manufacturing the jet hole plate which are high in quality while achieving the reduction in cost.

### BRIEF DESCRIPTION OF THE DRAWINGS

FIG. 1 is a schematic configuration diagram of an inkjet printer according to an embodiment.

FIG. 2 is a schematic configuration diagram of an inkjet head and an ink circulation mechanism according to the embodiment.

FIG. 3 is an exploded perspective view of a head chip according to the embodiment.

FIG. 4 is a cross-sectional view corresponding to the line IV-IV in FIG. 6.

FIG. 5 is a cross-sectional view corresponding to the line V-V in FIG. 6.

FIG. 6 is a diagram viewed along the arrow VI in FIG. 3.

FIG. 7 is a cross-sectional view corresponding to the line VII-VII in FIG. 6.

FIG. 8 is an enlarged view of the periphery of a nozzle hole.

FIG. 9 is a flowchart illustrating a method of manufacturing a nozzle plate.

FIG. 10 is a process diagram (cross-sectional view) illustrating the method of manufacturing the nozzle plate.

FIG. 11 is a process diagram (cross-sectional view) illustrating the method of manufacturing the nozzle plate.

FIG. 12 is a process diagram (cross-sectional view) illustrating the method of manufacturing the nozzle plate.

FIG. 13 is a process diagram (cross-sectional view) illustrating the method of manufacturing the nozzle plate.

### DETAILED DESCRIPTION OF THE PREFERRED EMBODIMENTS

An embodiment according to the present disclosure will hereinafter be described with reference to the drawings. In the embodiment and modified examples hereinafter described, components corresponding to each other will be denoted by the same reference symbols to omit the descriptions thereof in some cases. It should be noted that in the following description, expressions representing relative or absolute arrangements such as “parallel,” “perpendicular,” “center,” and “coaxial” not only represent strictly such arrangements, but also represent the state of being relatively displaced with a tolerance, or an angle or a distance to the extent that the same function can be obtained. In the following embodiment, the description will be presented citing an inkjet printer (hereinafter referred to simply as a printer) for performing recording on a recording target medium using ink (a liquid) as an example. It should be noted that the scale size of each member is arbitrarily modified so as to provide a recognizable size to the member in the drawings used in the following description.

### Printer 1

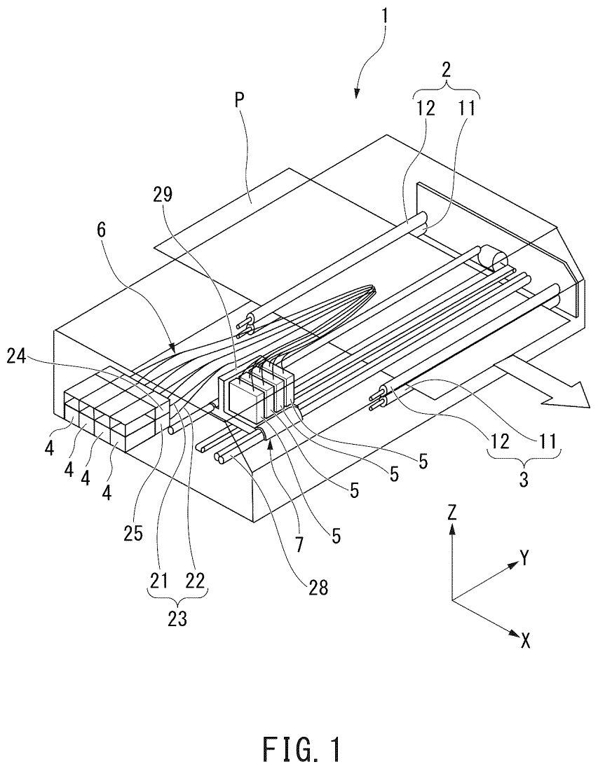

FIG. 1 is a schematic configuration diagram of a printer 1.

As shown in FIG. 1, the printer (a liquid jet recording device) 1 according to the present embodiment is provided with a pair of conveying mechanisms 2, 3, ink tanks 4, inkjet heads (liquid jet heads) 5, ink circulation mechanisms 6, and a scanning mechanism 7.

In the following explanation, the description is presented using an orthogonal coordinate system of X, Y, and Z as needed. In this case, the X direction coincides with a conveyance direction (a sub-scanning direction) of a recording target medium P (e.g., paper). The Y direction coincides with a scanning direction (a main scanning direction) of the scanning mechanism 7. The Z direction represents a height direction (a gravitational direction) perpendicular to the X direction and the Y direction. In the following explanation, the description will be presented defining an arrow side as a positive (+) side, and an opposite side to the arrow as a negative (−) side in the drawings in each of the X direction, the Y direction, and the Z direction. In the present embodiment, the +Z side corresponds to an upper side in the gravitational direction, and the −Z side corresponds to a lower side in the gravitational direction.

The conveyance mechanisms 2, 3 convey the recording target medium P toward the +X side. The conveyance mechanisms 2, 3 each include a pair of rollers 11, 12 extending in, for example, the Y direction.

The ink tanks 4 respectively contain ink of four colors such as yellow, magenta, cyan, and black. The inkjet heads 5 are configured so as to be able to respectively eject the four colors of ink, namely the yellow ink, the magenta ink, the cyan ink, and the black ink in accordance with the ink tanks 4 coupled thereto. It should be noted that water-based ink (electrically-conductive ink) using water as a solvent can be used as the ink contained in the ink tanks 4.

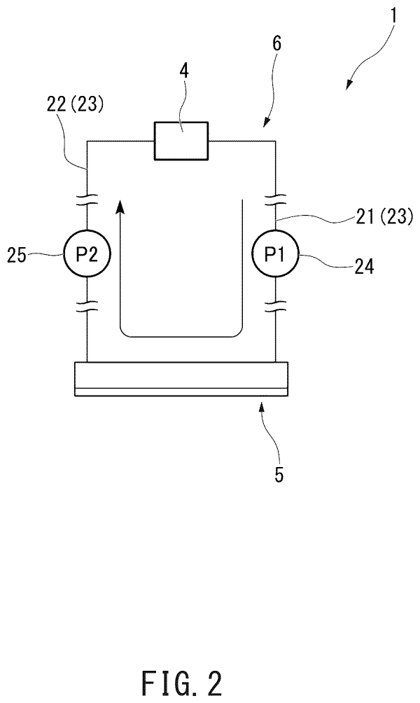

FIG. 2 is a schematic configuration diagram of the inkjet head 5 and the ink circulation mechanism 6.

As shown in FIGS. 1 and 2, the ink circulation mechanism 6 circulates the ink between the ink tank 4 and the inkjet head 5. Specifically, the ink circulation mechanism 6 is provided with a circulation flow path 23 having an ink supply tube 21 and an ink discharge tube 22, a pressure pump 24 coupled to the ink supply tube 21, and a suction pump 25 coupled to the ink discharge tube 22.

The pressure pump 24 pressurizes an inside of the ink supply tube 21 to deliver the ink to the inkjet head 5 through the ink supply tube 21. Thus, the ink supply tube 21 is provided with positive pressure with respect to the inkjet head 5.

The suction pump 25 depressurizes the inside of the ink discharge tube 22 to suction the ink from the inkjet head 5 through the ink discharge tube 22. Thus, the ink discharge tube 22 is provided with negative pressure with respect to the inkjet head 5. It is arranged that the ink can circulate between the inkjet head 5 and the ink tank 4 through the circulation flow path 23 by driving the pressure pump 24 and the suction pump 25.

The scanning mechanism 7 makes the inkjet heads 5 perform a reciprocal scan in the Y direction. The scanning mechanism 7 is provided with a guide rail 28 extending in the Y direction, and a carriage 29 movably supported by the guide rail 28.

### Inkjet Heads 5

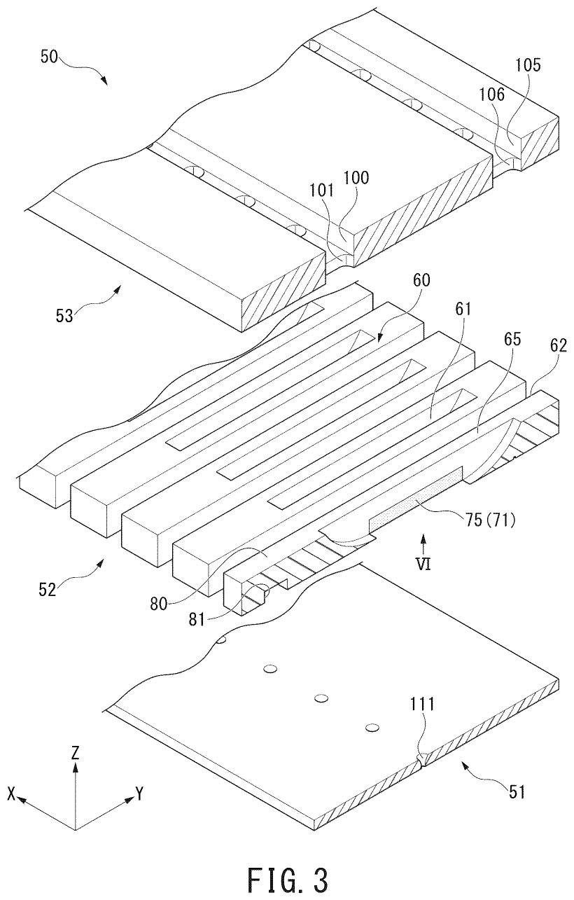

As shown in FIG. 1, the inkjet heads 5 are mounted on the carriage 29. In the illustrated example, the plurality of inkjet heads 5 is mounted on the single carriage 29 so as to be arranged side by side in the Y direction. The inkjet heads 5 are each provided with a head chip 50 (see FIG. 3), an ink supply unit (not shown) for coupling the ink circulation mechanism 6 and the head chip 50, and a control unit (not shown) for applying drive voltages to the head chip 50.

### Head Chip 50

FIG. 3 is an exploded perspective view of the head chip 50.

The head chip 50 shown in FIG. 3 is a so-called recirculating side-shoot type head chip 50 for ejecting the ink from a central portion in the extending direction (the Y direction) in the ejection channel 61 described later. The head chip 50 is provided with a nozzle plate 51, an actuator plate 52, and a cover plate 53. The head chip 50 is provided with a configuration in which the nozzle plate 51, the actuator plate 52, and the cover plate 53 are stacked on one another in this order in the Z direction.

The actuator plate 52 is formed of a piezoelectric material such as PZT (lead zirconate titanate). The actuator plate 52 is a so-called monopole substrate in which the polarization direction is one direction in the entire area in, for example, the Z direction. It should be noted that the actuator plate 52 may be a so-called chevron substrate in which the polarization direction is different between the positive side and the negative side in the Z direction. Although an example in which the actuator plate 52 is configured with a single substrate will be described in the present embodiment, this configuration is not a limitation. The actuator plate 52 may be configured with a plurality of (e.g., two) piezoelectric plates bonded to each other.

The actuator plate 52 is provided with a channel array 60. The channel array 60 includes ejection channels 61 filled with the ink, and non-ejection channels 62 not filled with the ink. The channels 61, 62 are alternately arranged at intervals in the X direction in the actuator plate 52. The configuration in which the channel extension direction coincides with the Y direction will be described in the present embodiment, but the channel extension direction can cross the Y direction.

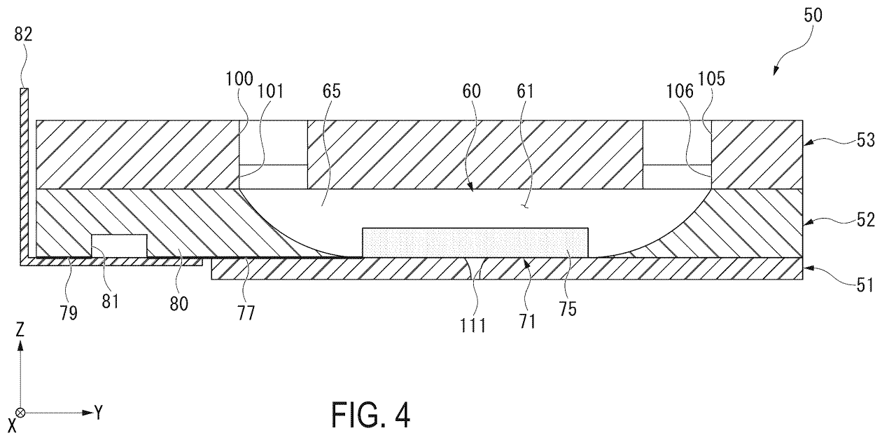

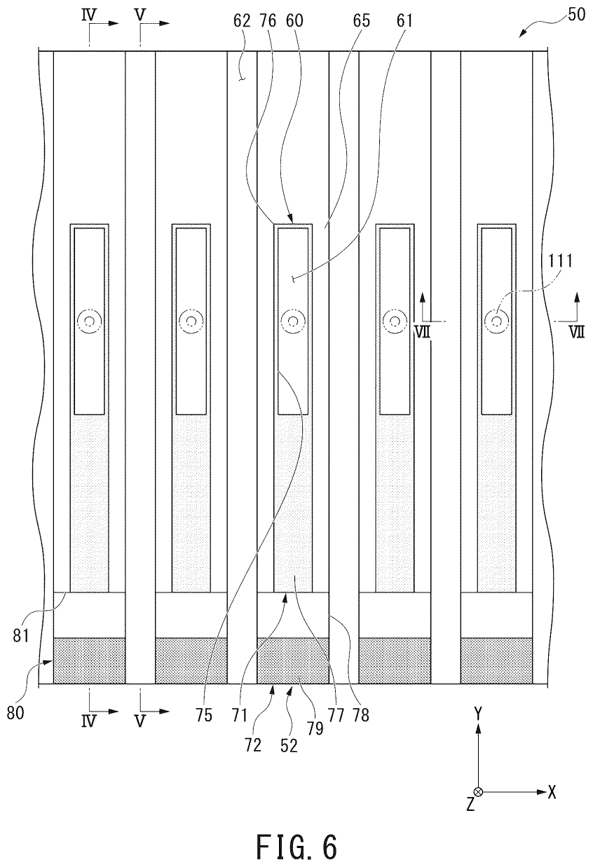

FIG. 4 is a cross-sectional view corresponding to the line IV-IV in FIG. 6.

As shown in FIG. 4, the ejection channel 61 is formed to have a circular arc shape convex downward when viewed from the X direction. The ejection channel 61 penetrates the actuator plate 52 in the Z direction in a central portion in the Y direction. The depth of the ejection channel 61 at a position gradually decreases as the position moves toward the outside in the Y direction in both end portions in the Y direction of the ejection channel 61.

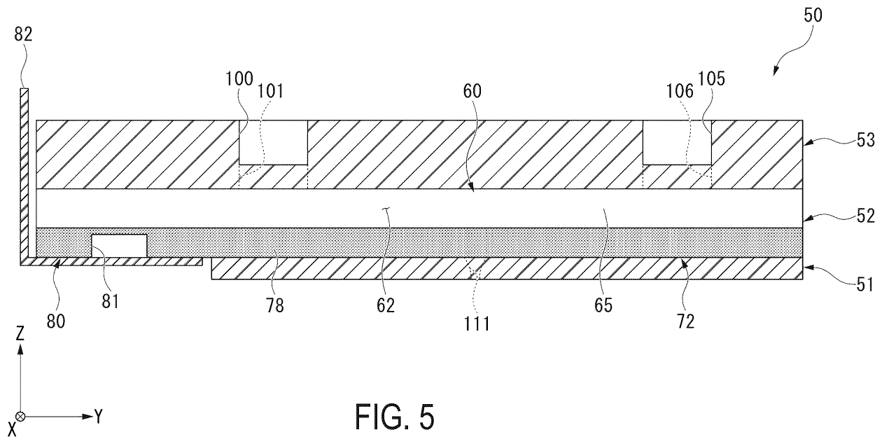

FIG. 5 is a cross-sectional view corresponding to the line V-V in FIG. 6.

As shown in FIG. 5, the non-ejection channel 62 linearly extends in the Y direction in the state of penetrating the actuator plate 52 in the Z direction. As shown in FIG. 3, in the actuator plate 52, a portion located between each of the ejection channels 61 and corresponding one of the non-ejection channels 62 constitutes a drive wall 65. Therefore, both sides in the X direction of each of the channels 61, 62 are surrounded by the pair of drive walls 65. Although the description is presented in the present embodiment citing the head chip 50 having the single channel array 60 as an example, it is possible to dispose a plurality of channel arrays 60 in the Y direction. On this occasion, it is preferable for the ejection channels 61 constituting the channel arrays 60 adjacent to each other to be arranged so as to be shifted as much as 1/n pitch with respect to an arrangement pitch of the ejection channels 61 in one of the channel arrays 60 assuming the number of the channel arrays 60 as n.

FIG. 6 is a diagram viewed along the arrow VI in FIG. 3.

As shown in FIGS. 4 to 6, the actuator plate 52 is provided with common wiring lines 71 and individual wiring lines 72. As shown in FIG. 4 and FIG. 6, the common wiring lines 71 are each provided with a common electrode 75, an extraction portion 76, and a common terminal 77.

The common electrode 75 is formed on inner side surfaces opposed to each other in the X direction out of the inner surfaces of the ejection channel 61. In the illustrated example, the common electrode 75 is formed from a lower surface of the actuator plate 52 to have a depth about a half the thickness in the Z direction.

The extraction portion 76 surrounds a lower end opening portion of the ejection channel 61 on the lower surface of the actuator plate 52. The extraction portion 76 is continued to the common electrode 75 at a lower end opening edge of the ejection channel 61.

The common terminal 77 is formed in a portion (hereinafter referred to as a tail part 80) located at the −Y side of the ejection channel 61 in the actuator plate 52. The common terminal 77 is disposed on the lower surface of the tail part 80 so as to correspond to each of the ejection channels 61. The common terminals 77 each extend linearly in the Y direction with respect to corresponding one of the ejection channels 61. A +Y-side end portion in the common terminal 77 is continued to the common electrode 75 via the extraction portion 76. The common wiring line 71 may have a configuration (a configuration in which the common electrode 75 and the common terminal 77 are directly continued to each other) not provided with the extraction portion 76.

As shown in FIG. 5 and FIG. 6, the individual wiring lines 72 are each provided with individual electrodes 78, and an individual terminal 79.

The individual electrodes 78 are each formed on one of the inner side surfaces opposed to each other in the X direction out of the inner surfaces of each of the non-ejection channels 62. In the illustrated example, the individual electrodes 78 are each formed from the lower surface side of the actuator plate 52 to have a depth about a half the thickness in the Z direction.

The individual terminal 79 is provided to a portion located at the −Y side of the common terminal 77 on the lower surface of the tail part 80. The individual terminal 79 is provided with a strip shape extending in the X direction. The individual terminal 79 couples the individual electrodes 78 opposed to each other in the X direction across the ejection channel 61 to each other at the lower end opening edges of the non-ejection channels 62 which are opposed to each other in the X direction across the ejection channel 61. In the tail part 80, in a portion located between the common terminal 77 and the individual terminal 79, there is formed a partition groove 81. The partition groove 81 extends in the X direction in the tail part 80. The partition groove 81 separates the common terminal 77 and the individual terminal 79 from each other.

To the lower surface of the tail part 80, there is pressure-bonded a flexible printed board 82. The flexible printed board 82 is coupled to the common terminals 77 and the individual terminals 79 on the lower surface of the tail part 80. The flexible printed board 82 is extracted toward the +Z side passing the outside of the actuator plate 52.

### Cover Plate 53

As shown in FIG. 3 and FIG. 4, the cover plate 53 is stacked on an upper surface (an opening surface) of the actuator plate 52 so as to cover an upper end opening portions of the channels 61, 62. The cover plate 53 is bonded to the upper surface of the actuator plate 52 via an adhesive or the like. In the cover plate 53, at a position overlapping the −Y-side end portion of the channel array 60 in plan view, there is formed an entrance common ink chamber 100. The entrance common ink chamber 100 extends in the X direction with a length sufficient for straddling, for example, the channel array 60, and at the same time, opens on an upper surface of the cover plate 53.

In the entrance common ink chamber 100, at the positions overlapping the respective ejection channels 61 in the plan view, there are formed entrance slits 101. The entrance slits 101 each communicate the −Y-side end portion of corresponding one of the ejection channels 61 and the entrance common ink chamber 100 with each other.

In the cover plate 53, at a position overlapping the +Y-side end portion of the channel array 60 in the plan view, there is formed an exit common ink chamber 105. The exit common ink chamber 105 extends in the X direction with a length sufficient for straddling, for example, the channel array 60, and at the same time, opens on the upper surface of the cover plate 53.

In the exit common ink chamber 105, at the positions overlapping the respective ejection channels 61 in the plan view, there are formed exit slits 106. The exit slits 106 each communicate the +Y-side end portion of corresponding one of the ejection channels 61 and the exit common ink chamber 105 with each other. Therefore, the entrance slits 101 and the exit slits 106 are communicated with the respective ejection channels 61 on the one hand, but are not communicated with the non-ejection channels 62 on the other hand.

### Nozzle Plate 51

As shown in FIG. 3, the nozzle plate (a plate main body) 51 is bonded to the lower surface (the opening surface) of the actuator plate 52 via an adhesive or the like. In the present embodiment, the nozzle plate 51 is formed of a metal material (such as SUS or Ni—Pd) or the like. It should be noted that it is possible for the nozzle plate 51 to have a single layer structure or a laminate structure with a synthetic resin material (e.g., polyimide), glass, silicon, or the like besides the metal material.

The nozzle plate 51 is provided with a plurality of nozzle holes (jet holes) 111. The nozzle holes 111 are arranged at intervals in the X direction. The nozzle holes 111 penetrate portions of the nozzle plate 51 in the Z direction, the portions overlapping the ejection channels 61 in the plan view, respectively. The details of the nozzle holes 111 will hereinafter be described using one of the nozzle holes 111 as an example.

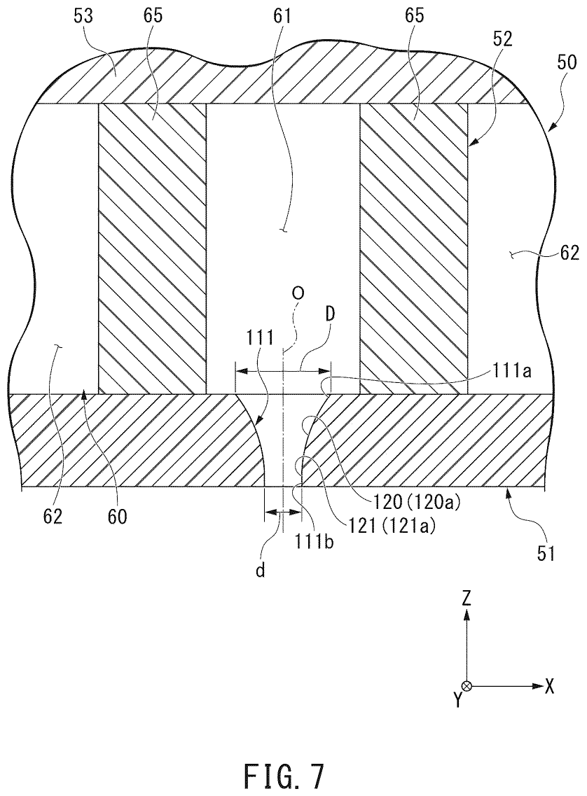

FIG. 7 is a cross-sectional view corresponding to the line VII-VII in FIG. 6.

As shown in FIG. 7, each of the nozzle holes 111 is formed in a circular shape centered on an axis line O in the plan view viewed from the Z direction. An upper end opening portion 111a of the nozzle hole 111 opens on an upper surface of the nozzle plate 51. The nozzle holes 111 are respectively communicated with central portions in the Y direction of the ejection channels 61 through the upper end opening portions 111a. Therefore, the non-ejection channels 62 are not communicated with the nozzle holes 111, but are covered with the nozzle plate 51 from below. On the other hand, a lower end opening portion 111b of the nozzle hole 111 opens on a lower surface of the nozzle plate 51. The lower end opening portion 111b of each of the nozzle holes 111 is communicated with an outside of the head chip 50. The description will hereinafter be presented assuming that a direction perpendicular to the axis line O is the radial direction of the nozzle hole 111.

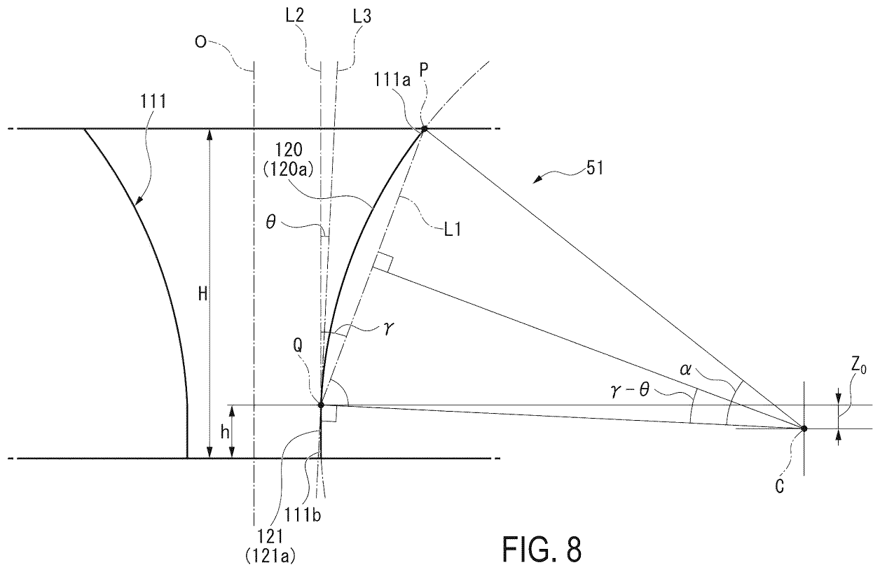

FIG. 8 is an enlarged view of the periphery of the nozzle hole 111.

As shown in FIG. 7 and FIG. 8, the nozzle hole 111 is provided with a taper portion 120 and a straight portion 121.

The taper portion 120 forms an upper part (an upstream portion) of the nozzle hole 111. The taper portion 120 is formed in a trumpet shape arranged concentrically with the axis line O. Specifically, in a cross-sectional surface along the Z direction, the inside diameter at a position of the taper portion 120 gradually decreases as the position moves downward due to a circular-arc inner peripheral surface 120a formed in a circular arc shape convex inward in the radial direction. That is, the circular-arc inner peripheral surface 120a bulges inward in the radial direction with respect to a straight line L1 (a chord of the circular-arc inner peripheral surface 120a) connecting an intersection P of the circular-arc inner peripheral surface 120a and the upper surface of the nozzle plate 51 and an intersection Q of the circular-arc inner peripheral surface 120a and a straight inner peripheral surface 121a. It should be noted that the taper portion 120 can be reworded as a curved surface portion, a curved surface declining portion, or the like.

The circular-arc inner peripheral surface 120a is formed to have a uniform curvature radius r throughout the entire length in the Z direction. It should be noted that a central angle α of the circular-arc inner peripheral surface 120a is set in a range of, for example, 20° to 60°. Further, in the present embodiment, the center of curvature C of the circular-arc inner peripheral surface 120a is located within a dimension in the Z direction in the nozzle plate 51, and in a portion (within a dimension of the straight portion 121) located a dimension Z0 below a lower end edge of the taper portion 120. However, the position in the Z direction of the center of curvature C can appropriately be changed.

An upper end opening portion of the taper portion 120 forms the upper end opening portion (an upstream opening portion) 111a of the nozzle hole 111. In the illustrated example, the inside diameter D (a maximum inside diameter portion of the taper portion 120) of the upper end opening portion 111a of the nozzle hole 111 is smaller than a dimension in the X direction in the ejection channel 61. Therefore, the whole of the nozzle hole 111 is disposed within a range of the dimension in the X direction of the ejection channel 61 in the plan view.

The straight portion 121 is connected to a lower end portion of the taper portion 120, and at the same time, forms a lower part (a downstream portion) of the nozzle hole 111. The straight portion 121 is arranged concentrically with the axis line O, and at the same time, formed in a cylindrical shape. Specifically, the straight portion 121 is formed to have a uniform inside diameter throughout the entire length in the Z direction due to the straight inner peripheral surface 121a extending in the Z direction in a linear shape in the cross-sectional surface along the Z direction. The upper end edge of the straight inner peripheral surface 121a is smoothly continued to the lower end edge of the circular-arc inner peripheral surface 120a.

A lower end opening portion of the straight portion 121 forms the lower end opening portion 111b of the nozzle hole 111. Therefore, an inside diameter d of the lower end opening portion 111b of the nozzle hole 111 is equal to the inside diameter of the straight portion 121.

In the present embodiment, a dimension h of the straight portion 121 is preferably no smaller than 1/10 of the inside diameter d of the straight portion 121, and no larger than ½ of a dimension H of the nozzle hole 111 (d/10≤h≤H/2). Further, the dimension h of the straight portion 121 is more preferably no smaller than ¼ of the inside diameter d of the straight portion 121 (d/4≤h).

As shown in FIG. 8, when the dimension (the thickness) in the Z direction of the nozzle plate 51 is denoted by H, the dimension in the Z direction of the straight portion 121 is denoted by h, and the curvature radius of the circular-arc inner peripheral surface 120a is denoted by r, these dimensions are set in a range of 1<r/(H-h)≤5. That is, the curvature radius r of the circular-arc inner peripheral surface 120a is set in a range larger than the same size of the dimension (H-h) in the Z direction in the taper portion 120 and no larger than 5 times thereof.

In the cross-sectional surface along the Z direction, an angle between the straight line L1 connecting the intersection P and the intersection Q and an imaginary line L2 extending in the Z direction is denoted by γ. In the cross-sectional surface along the Z direction, an angle between a tangent line L3 of the circular-arc inner peripheral surface 120a at a connection portion (the intersection Q) of the circular-arc inner peripheral surface 120a and the straight inner peripheral surface 121a and the imaginary line L2 is denoted by θ. In this case, the angle θ is preferably no smaller than 0° and no larger than γ/2 (0°≤θ≤γ/2). Further, the angle θ is preferably no smaller than 0.1° and no larger than 10° (0.1°≤θ≤10°).

It should be noted that regarding the nozzle hole 111, numerical value examples of the variety of dimensions are as follows.
The thickness H of the nozzle plate 51: 40 μm to 60 μm
The inside diameter D of the upper end opening portion 111a: 40 μm to 90 μm
The inside diameter d of the lower end opening portion 111b: 15 μm to 40 μm
The curvature radius r: 40 μm to 150 μm
The dimension h of the straight portion 121: 2 μm to 35 μm
The dimension (H-h) of the taper portion 120: 38 μm to 58 μm

On that basis, the dimensions of the nozzle hole 111 satisfying the conditions described above can be set as, for example, described below.
The thickness H of the nozzle plate 51: 50 μm
The inside diameter D of the upper end opening portion 111a: 65 μm
The inside diameter d of the lower end opening portion 111b: 30 μm
The dimension h of the straight portion 121: 10 μm
The dimension (H-h) of the taper portion 120: 40 μm
r/(H-h)=2.5
The curvature radius r: 90 μm
θ=10°

### Operation Method of Printer 1

Then, there will be described below when a character, a figure, or the like is recorded on the recording target medium P using the printer 1.

It is assumed that in the printer 1, the ink tanks 4 are sufficiently filled with the ink of respective colors different from each other as an initial state. There is created a state in which the inkjet heads 5 are filled with the ink in the ink tanks 4 via the ink circulation mechanisms 6, respectively.

Under such an initial state, when making the printer 1 operate, the recording target medium P is conveyed toward the +X side while being pinched by the rollers 11, 12 of the conveyance mechanisms 2, 3. By the carriage 29 moving in the Y direction at the same time as the conveyance of the recording target medium P, the inkjet heads 5 mounted on the carriage 29 make a reciprocal motion in the Y direction.

While the inkjet heads 5 make the reciprocal motion, the ink is appropriately ejected toward the recording target medium P from each of the inkjet heads 5. Thus, it is possible to perform recording of the character, the image, and the like on the recording target medium P.

Here, the operation of each of the inkjet heads 5 will hereinafter be described in detail.

In such a recirculating side-shoot type inkjet head 5 as in the present embodiment, first, by making the pressure pump 24 and the suction pump 25 shown in FIG. 2 operate, the ink is circulated in the circulation flow path 23. In this case, as shown in FIG. 4, the ink flowing through the ink supply tube 21 is supplied to the inside of each of the ejection channels 61 through the entrance common ink chamber 100 and the entrance slits 101. The ink supplied to the inside of each of the ejection channels 61 flows through the ejection channels 61 in the Y direction. Subsequently, the ink is discharged to the exit common ink chamber 105 through the exit slits 106, and is then returned to the ink tank 4 through the ink discharge tube 22. Thus, it is possible to circulate the ink between the inkjet head 5 and the ink tank 4.

When the reciprocation of the inkjet head 5 is started due to the translation of the carriage 29 (see FIG. 1), the drive voltages are applied between the common electrodes 75, and the individual electrodes 78 via the flexible printed board 82. On this occasion, the drive voltage is applied between the electrodes 75, 78 by setting the individual electrode 78 at a drive potential Vdd, and the common electrode 75 at a reference potential GND. Then, each of the drive walls 65 flexurally deforms to form a V-shape centering on an intermediate portion in the Z direction. In other words, the drive walls 65 deform so that the volume of the ejection channel 61 increases.

After the volume of each of the ejection channels 61 is increased, the voltage applied between the common electrode 75 and the individual electrode 78 is set to zero. Then, the drive walls 65 are restored, and the volume of the ejection channel 61 having once increased is restored to the original volume. Thus, the internal pressure of the ejection channel 61 increases to pressurize the ink. As a result, the ink is ejected through the nozzle hole 111. Specifically, the ink which has flowed into the nozzle hole 111 is gradually increased in flow rate in the process of passing through the taper portion 120, and is then straightened in the process of passing through the straight portion 121. The ink having passed through the straight portion 121 is ejected as a ligament, and then turns to a droplet while flying toward the recording target medium P. Further, by the droplet landing on the recording target medium P, it is possible to record the character, the image, and the like on the recording target medium P.

### Method of Manufacturing Nozzle Plate 51

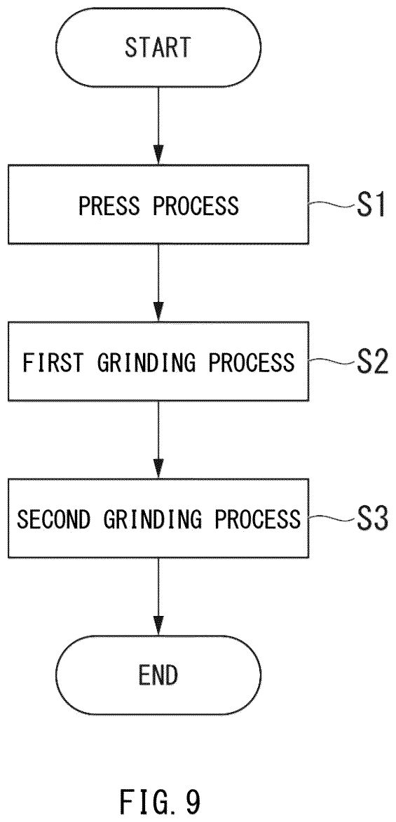

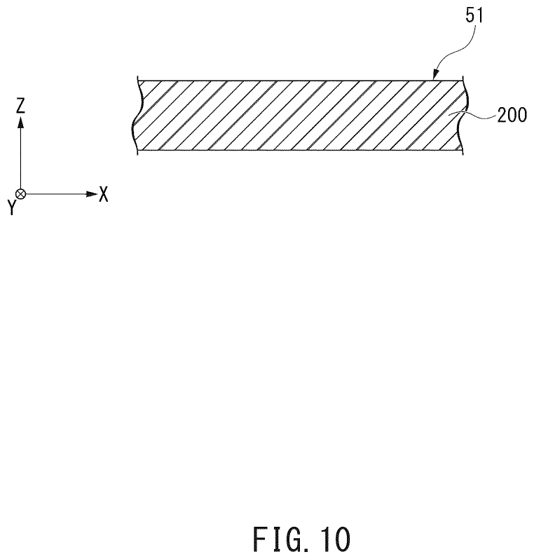

FIG. 9 is a flowchart illustrating a method of manufacturing the nozzle plate 51. FIGS. 10 to 13 are each a process diagram illustrating the method of manufacturing the nozzle plate 51. It should be noted that there will hereinafter be described when forming the nozzle holes 111 using one of the nozzle holes 111 as an example. However, the plurality of nozzle holes 111 may be formed in a lump.

As shown in FIG. 9, the nozzle plate 51 in the present embodiment is manufactured through a press process S1, a first grinding process S2, and a second grinding process S3.

As shown in FIGS. 9 to 11, in the press process S1, a press work is performed on a plate main body 200 which turns to the nozzle plate 51 to thereby form a recessed portion 230 which turns to the nozzle hole 111. Specifically, in the press process S1, the plate main body 200 is first set on a die 211. The die 211 is provided with a through hole 210 at a position corresponding to a formation region of the nozzle hole 111.

Subsequently, in the plate main body 200, the formation region of the nozzle hole 111 is pressed with a punch 220 from an upper surface side of the plate main body 200. A tip portion of the punch 220 is provided with a shaping portion 221 which copies an interior shape of the nozzle hole 111. In the present embodiment, the shaping portion 221 is provided with a taper shaping portion 221a, and a straight shaping portion 221b continued to a tip of the taper shaping portion 221a. The straight shaping portion 221b is formed to be longer than the dimension h of the straight portion 121.

Then, when the plate main body 200 is pressed with the punch 220, the recessed portion 230 which copies an exterior shape of the shaping portion 221 is provided to the plate main body 200. On this occasion, a portion (a bulging portion 231) of the plate main body 200 pushed out by the punch 220 enters the through hole 210. The bulging portion 231 bulges downward with respect to a lower surface of the plate main body 200. Therefore, the recessed portion 230 is formed to have a depth larger than the thickness H of the plate main body 200.

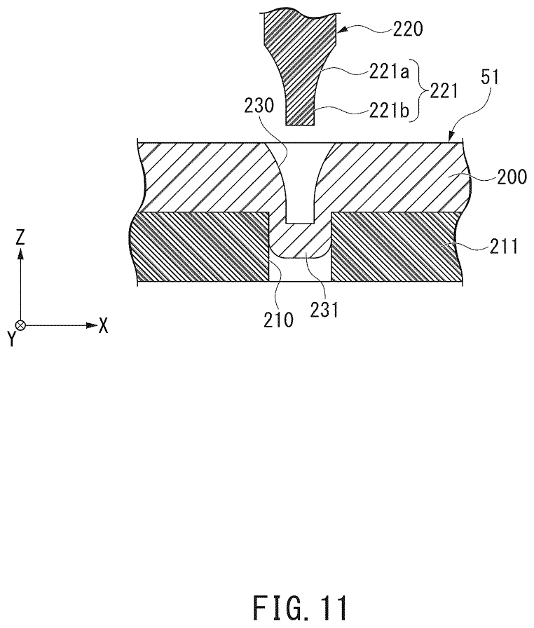

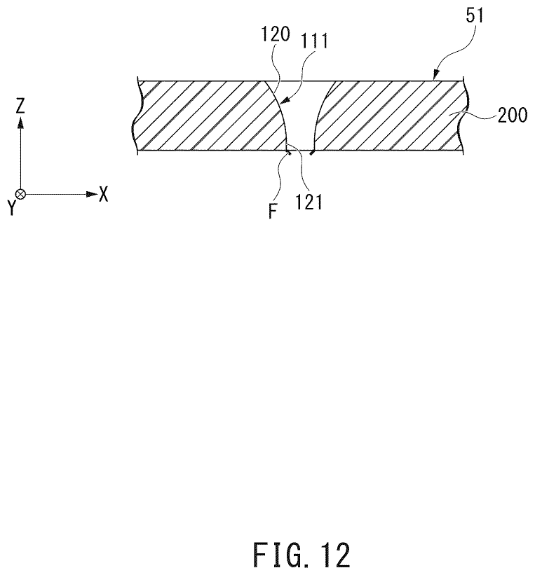

Then, as shown in FIG. 9, FIG. 11, and FIG. 12, in the first grinding process S2, the recessed portion 230 described above is made to penetrate. In the first grinding process S2, the lower surface of the plate main body 200 is ground by, for example, mechanical grinding to remove the bulging portion 231. It should be noted that in the first grinding process S2, planarization of the plate main body 200 may be performed in addition to the removal of the bulging portion 231.

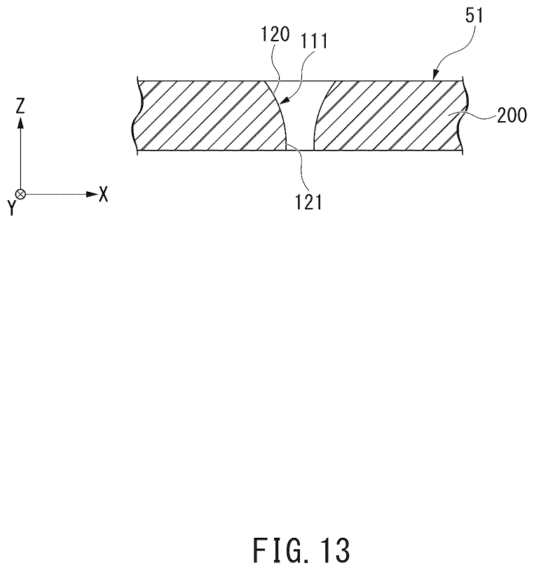

As shown in FIG. 9, FIG. 12, and FIG. 13, in the second grinding process S3, burrs F generated by the first grinding process S2 are removed. In the second grinding process S3, chemical grinding, electrolytic grinding, chemical mechanical polishing, or the like is performed on at least the surface (the lower surface in the illustrated example) where the burrs F are generated out of the plate main body 200.

In this way, the nozzle plate 51 in the present embodiment is formed.

As described above, in the nozzle plate 51 in the present embodiment, the nozzle holes (jet holes) 111 provided to the nozzle plate (the plate main body) 51 are each provided with the taper portion 120 which has the circular-arc inner peripheral surface 120a formed in the circular arc shape having the uniform curvature radius r in the cross-sectional surface along the Z direction (a jet direction), opens on the upper surface (a first surface) of the nozzle plate 51, and in which the inside diameter at a position gradually decreases as the position moves downward (downstream), and the straight portion 121 which is continued to the lower end portion (a downstream end portion) of the taper portion 120, opens on the lower surface (a second surface) of the nozzle plate 51, and is formed to have the uniform inside diameter d throughout the entire length in the Z direction.

According to this configuration, the ink which has flowed into the nozzle hole 111 is gradually increased in flow rate in the process of passing through the taper portion 120, and is then straightened in the process of passing through the straight portion 121. Thus, it is possible to eject the ink from the nozzle hole 111 in the state in which a velocity component in the radial direction of the nozzle hole 111 is reduced. On this occasion, since the inner peripheral surface of the taper portion 120 is formed as the circular-arc inner peripheral surface 120a, the velocity component is easily reduced in the radial direction of the nozzle hole 111 as the ink moves downstream compared to when, for example, the inner peripheral surface of the taper portion is formed in a linear shape. Further, it is possible to suppress an occurrence of the turbulent flow in the connection portion of the taper portion 120 and the straight portion 121. Thus, it is possible to reduce the deflection and the variations in ejection direction and ejection velocity of the droplet. Further, it becomes possible to suppress the occurrence of the satellites to thereby perform the small droplet printing and the wide gap printing with high quality.

Moreover, since the straight portion 121 forms the lower end opening portion 111b of the nozzle hole 111, it is possible to reduce a dimensional variation with respect to the inside diameter d of the lower end opening portion 111b compared to a configuration in which, for example, the whole of the nozzle hole is formed as the taper portion. Thus, it is possible to provide the nozzle plate 51 low in cost and high in quality.

In particular, since the dimensions are set within the range of 1<r/(H-h), it is possible to suppress a growth in size of the inside diameter D with respect to the upper end opening portion 111a of the nozzle hole 111. Thus, when providing the plurality of nozzle holes 111 to the nozzle plate 51, it becomes possible to miniaturize the nozzle holes 111 and to narrow a pitch of the nozzle holes 111, and it becomes possible to reduce the size of the head chip 50 in which the nozzle plate 51 is installed, and to improve the print quality.

In the nozzle plate 51 in the present embodiment, the dimensions are set to satisfy r/(H-h)≤5.

According to this configuration, by setting the dimensions to satisfy r/(H-h)≤5, a change in inside diameter of the nozzle hole 111 in the taper portion 120 can be made gentle. Thus, a change in velocity in the process of passing through the taper portion 120 can be made gentle, and thus, the occurrence of the turbulent flow in the nozzle hole 111 can be suppressed. As a result, it is possible to achieve a further improvement in print quality.

In the nozzle plate 51 in the present embodiment, the straight portion 121 has the straight inner peripheral surface 121a which linearly extends in the Z direction in the cross-sectional surface along the Z direction, and is continued to the circular-arc inner peripheral surface 120a at the upper end edge. In the cross-sectional surface along the Z direction, when the angle between the direction of the tangent line L3 of the circular-arc inner peripheral surface 120a at the connection portion of the circular-arc inner peripheral surface 120a and the straight inner peripheral surface 121a and the imaginary line L2 extending in the Z direction is denoted by θ, the angle θ is set to satisfy 0°≤θ≤γ/2.

According to this configuration, since it is possible to smoothly connect the taper portion 120 (the circular-arc inner peripheral surface 120a) and the straight portion 121 (the straight inner peripheral surface 121a) to each other, it is possible to suppress the occurrence of the turbulent flow in the connection portion of the taper portion 120 and the straight portion 121.

In the nozzle plate 51 in the present embodiment, the angle θ is set to satisfy θ≤10°.

According to this configuration, since it is possible to smoothly connect the taper portion 120 and the straight portion 121 to each other, it is possible to suppress the occurrence of the turbulent flow in the connection portion of the taper portion 120 and the straight portion 121. Further, it is possible to suppress a growth in size of the inside diameter D with respect to the upper end opening portion 111a of the nozzle hole 111 while maintaining the state in which the circular-arc inner peripheral surface 120a is sufficiently curved.

In the nozzle plate 51 in the present embodiment, the angle θ is set to satisfy 0.1°≤θ.

According to this configuration, when, for example, forming the nozzle holes 111 with the press work, it is possible to improve mold releasability of the punch 220 taking the dimensional variation into consideration.

In the nozzle plate 51 in the present embodiment, when the inside diameter of the straight portion 121 is denoted by d, the dimensions are set to satisfy d/10≤h≤H/2.

According to this configuration, since the dimension h of the straight portion 121 is set to be no larger than a half the dimension H of the nozzle plate 51, it is easy to ensure the dimension (H-h) of the taper portion 120. Thus, it is easy to reduce the velocity component in the radial direction of the nozzle hole 111 as the ink moves downstream. Further, it is possible to suppress an occurrence of the turbulent flow in the connection portion of the taper portion 120 and the straight portion 121.

On that basis, since the dimension h of the straight portion 121 is set to be no smaller than 1/10 of the inside diameter d of the straight portion 121, it is possible to exert the straightening effect of the ink in the straight portion 121.

In the nozzle plate 51 in the present embodiment, the dimensions are set to satisfy d/4≤h.

According to this configuration, it is possible to ensure the dimension h of the straight portion 121 to make it possible to increase the straightening effect.

Since the head chip 50, the inkjet head 5, and the printer 1 in the present embodiment are each provided with the nozzle plate 51 described above, it is possible to provide the head chip 50, the inkjet head 5, and the printer 1 high in print quality.

The method of manufacturing the nozzle plate 51 in the present embodiment is provided with the press process of performing the press work from the upper surface of the plate main body 200 using the punch 220 having the taper shaping portion 221a for shaping the taper portion 120 and the straight shaping portion 221b that is continued to the tip of the taper shaping portion 221a, and at the same time, shapes the straight portion 121.

According to this configuration, it is possible to accurately and promptly shape the nozzle holes 111 each having the taper portion 120 and the straight portion 121 in the desired shape compared to when manufacturing the nozzle plate 51 having the nozzle holes 111 by, for example, plating.

It should be noted that the scope of the present disclosure is not limited to the embodiments described above, but a variety of modifications can be applied within the scope or the spirit of the present disclosure.

For example, in the embodiments described above, the description is presented citing the inkjet printer 1 as an example of the liquid jet recording apparatus, but the liquid jet recording apparatus is not limited to the printer. For example, a facsimile machine, an on-demand printing machine, and so on can also be adopted.

In the embodiments described above, there is explained when the recording target medium P is paper, but this configuration is not a limitation. The recording target medium P is not limited to paper, but can also be a metal material or a resin material, and can also be food or the like.

In the embodiment described above, there is described the configuration in which the head chips and the liquid jet heads are used in the liquid jet recording apparatus, but this configuration is not a limitation. Specifically, the liquid to be jetted from the head chips and the liquid jet heads is not limited to what is landed on the recording target medium, but can also be, for example, a medical solution to be blended during a dispensing process, a food additive such as seasoning or a spice to be added to food, or fragrance to be sprayed in the air.

In the embodiments described above, the description is presented citing the head chip of the side-shoot type as an example, but this configuration is not a limitation. The nozzle plate 51 according to the present disclosure may be used in a head chip of a so-called edge-shoot type in which the nozzle hole 111 is disposed in an end portion in an extending direction of the ejection channel. Further, the head chip may be of a so-called roof-shoot type in which a direction of the pressure applied to the ink and the ejection direction of the ink are made the same as each other.

In the embodiments described above, there is explained the configuration in which the Z direction coincides with the gravitational direction, but this configuration is not a limitation, and it is also possible to set the Z direction to a direction along the horizontal direction.

In the embodiment described above, there is described the configuration in which the dimensions are set to satisfy 1<r/(H-h)≤5, but this configuration is not a limitation. In the present disclosure, it is sufficient for the dimensions to satisfy at least 1<r/(H-h).

In the embodiment described above, there is described the configuration in which the angle θ satisfies 0°≤θ≤γ/2, but this configuration is not a limitation.

In the embodiment described above, the configuration in which the dimension h of the straight portion 121 is no smaller than 1/10 of the inside diameter d of the straight portion 121, and no larger than ½ of the dimension H of the nozzle hole 111 is described, but this configuration is not a limitation.

In the embodiment described above, there is described the configuration in which the nozzle plate 51 is bonded to the lower surface of the actuator plate 52, but this configuration is not a limitation. For example, an intermediate plate or the like may be disposed between the actuator plate 52 and the nozzle plate 51. The intermediate plate is provided with communication holes which communicate the nozzle holes 111 and the ejection channels 61 with each other.

Besides the above, it is arbitrarily possible to replace the constituents in the embodiments described above with known constituents within the scope or the spirit of the present disclosure, and it is also possible to arbitrarily combine the modified examples described above with each other.

What is claimed is:

1. A jet hole plate comprising
a plate main body provided with a jet hole configured to jet a liquid, wherein
when defining a surface facing upstream in a jet direction of the liquid as a first surface, and a surface facing downstream as a second surface,
the jet hole includes
a taper portion which has a circular-arc inner peripheral surface formed in a circular arc shape having a uniform curvature radius in a cross-sectional surface along the jet direction, opens on the first surface, and in which an inside diameter at a position gradually decreases as the position moves toward the downstream, and
a straight portion which is connected to a downstream end portion of the taper portion, opens on the second surface, and is formed to have a uniform inside diameter throughout an entire length in the jet direction,
when a dimension in the jet direction of the plate main body is denoted by H, a dimension in the jet direction of the straight portion is denoted by h, and a curvature radius of the circular-arc inner peripheral surface is denoted by r,
1<r/(H-h) is satisfied.

2. The jet hole plate according to claim 1, wherein
r/(H-h)≤5 is satisfied.

3. The jet hole plate according to claim 1, wherein
the straight portion has a straight inner peripheral surface which extends linearly in the jet direction in the cross-sectional surface along the jet direction, and is connected to the circular-arc inner peripheral surface in an upstream end portion in the jet direction, and
when an angle between a straight line connecting an intersection of the circular-arc inner peripheral surface and the first surface and an intersection of the circular-arc inner peripheral surface and the straight inner peripheral surface and the jet direction in the cross-sectional surface along the jet direction is denoted by γ, and
an angle between a tangent direction of the circular-arc inner peripheral surface at a connection portion of the circular-arc inner peripheral surface and the straight inner peripheral surface and the jet direction in the cross-sectional surface along the jet direction is denoted by θ,
0°≤θ≤γ/2 is satisfied.

4. The jet hole plate according to claim 3, wherein
θ≤10° is satisfied.

5. The jet hole plate according to claim 3, wherein
0.1°≤θ is satisfied.

6. The jet hole plate according to claim 1, wherein
when an inside diameter of the straight portion is denoted by d,
d/10≤h≤H/2 is satisfied.

7. The jet hole plate according to claim 6, wherein
d/4≤h is satisfied.

8. A head chip comprising
the jet hole plate according to claim 1.

9. A liquid jet head comprising
the head chip according to claim 8.

10. A liquid jet recording apparatus comprising
the liquid jet head according to claim 9.

11. A method of manufacturing a jet hole plate which is provided with
a plate main body provided with a jet hole configured to jet a liquid, wherein
when defining a surface facing upstream in a jet direction of the liquid as a first surface, and a surface facing downstream as a second surface,
the jet hole includes
a taper portion which opens on the first surface and in which an inside diameter at a position gradually decreases as the position moves toward the downstream, and
a straight portion which is connected to a downstream end portion of the taper portion, opens on the second surface, and is formed to have a uniform inside diameter throughout an entire length in the jet direction,
the method comprising
a press process of performing a press work from the first surface of the plate main body using a punch including a taper shaping portion configured to shape the taper portion and a straight shaping portion which is continued to a tip of the taper shaping portion and is configured to shape the straight portion.
